(19) United States
(12) Patent Application Publication
(10) Pub. No.: US 2024/0204545 A1
(43) Pub. Date: Jun. 20, 2024

(54) POWER SUPPLY APPARATUS

(71) Applicant: MURATA MANUFACTURING CO., LTD., Kyoto (JP)

(72) Inventor: Jusuke SHIMURA, Kyoto (JP)

(21) Appl. No.: 18/588,899

(22) Filed: Feb. 27, 2024

Related U.S. Application Data
(63) Continuation of application No. PCT/JP2022/030770, filed on Aug. 12, 2022.

(30) Foreign Application Priority Data
Aug. 31, 2021 (JP) 2021-141992

(51) Int. Cl. H02J 7/00; H01M 10/46; H01M 50/269

(52) U.S. Cl. CPC H02J 7/0034; H01M 10/46; H01M 50/269; H02J 7/0024; H02J 7/0047; H02J 7/007

(57) ABSTRACT

A power supply apparatus according to an embodiment of the present technology includes secondary battery units and a controller. The secondary battery units are coupled in parallel to each other. The controller controls discharging of the secondary battery units. The secondary battery units each include secondary batteries and a switching unit. The switching unit switches coupling of the secondary batteries. The controller switches coupling between a first secondary battery and each of one or more second secondary batteries from parallel coupling to series coupling by controlling the switching unit. The first secondary battery is any one of the secondary batteries. The one or more second secondary batteries are one or more of the secondary batteries other than the first secondary battery.

### CROSS REFERENCE TO RELATED APPLICATIONS

The present application is a continuation of PCT patent application no. PCT/JP2022/030770, filed on Aug. 12, 2022, which claims priority to Japanese patent application no. 2021-141992, filed on Aug. 31, 2021, the entire contents of which incorporated herein by reference.

### BACKGROUND

The present technology relates to a power supply apparatus including secondary batteries.

In recent years, for example, electric automobiles and hybrid automobiles have been widely used. In addition, power generation devices using, for example, photovoltaic power generation and wind power generation that are unstable in generated power and for which leveling of the power is to be performed have also been widely used. The widespread use of such automobiles and such power generation devices has led to a rapid rise in demand of various secondary batteries including, without limitation, lithium-ion secondary batteries.

In a secondary battery, for example, when an internal short circuit is caused by a foreign object (e.g., a nail or a metal piece) penetrating the secondary battery from an outside, Joule heat is generated around a short-circuited part. Depending on a generation state of the Joule heat, thermal runaway can occur in the secondary battery. Such an internal short circuit in the secondary battery due to a foreign object can occur, for example, upon a crash accident of a mobile body in a case of the secondary battery mounted on the mobile body, or when the foreign object falls on the secondary battery due to a disaster such as an earthquake. An internal short circuit can also be caused by a dendrite.

As existing techniques of reducing a risk of ignition caused by an internal short circuit, for example, two or more secondary batteries are disposed in parallel, and a secondary battery in which an internal short circuit has occurred is subjected to emergency discharge by means of a maximum power point tracking (MPPT) circuit to be maximized in output power. For example, a secondary battery in which an internal short circuit has occurred is subjected to emergency discharge by being coupled in series to another secondary battery in which no internal short circuit has occurred, by means of a closed circuit.

### SUMMARY

The present technology relates to a power supply apparatus including secondary batteries.

A method described in the Background section, however, interrupts power supply to electronic equipment upon emergency discharge, and is therefore unsuitable for an application in which loss of power is unacceptable even for an instant. It is therefore desirable to provide a power supply apparatus that prevents interruption of power supply upon emergency discharge.

A power supply apparatus according to an embodiment of the present technology includes secondary battery units and a controller. The secondary battery units are coupled in parallel to each other. The controller controls discharging of the secondary battery units. The secondary battery units each include secondary batteries and a switching unit. The switching unit switches coupling of the secondary batteries. The controller switches coupling between a first secondary battery and each of one or more second secondary batteries from parallel coupling to series coupling by controlling the switching unit. The first secondary battery is any one of the secondary batteries. The one or more second secondary batteries are one or more of the secondary batteries other than the first secondary battery.

According to the power supply apparatus of an embodiment of the present technology, the coupling between the first secondary battery and the one or more second secondary batteries is to be switched from the parallel coupling to the series coupling. Accordingly, for example, when an internal short circuit occurs in the first secondary battery, it is possible to cause a discharge current of the secondary battery unit including the first secondary battery in which the internal short circuit has occurred to flow into another secondary battery unit. This makes it possible to perform emergency discharge of the first secondary battery in which the internal short circuit has occurred, without interrupting power supply to a load.

Note that effects of the present technology are not necessarily limited to those described herein and may include any of a series of suitable effects.

### BRIEF DESCRIPTION OF THE FIGURES

FIG. 1 is a diagram illustrating an example of a circuit configuration of a power supply apparatus according to an embodiment of the present technology.

FIG. 2 is a diagram illustrating a modification of the circuit configuration of the power supply apparatus illustrated in FIG. 1.

FIG. 3 is a diagram illustrating an example of an emergency discharge procedure for the power supply apparatus illustrated in FIG. 1.

FIG. 4 is a diagram illustrating a state of normal discharge in the power supply apparatus illustrated in FIG. 1.

FIG. 5 is a simplified diagram illustrating the state of the normal discharge.

FIG. 6 is a diagram illustrating a state in which a short circuit has occurred in the power supply apparatus illustrated in FIG. 1.

FIG. 7 is a diagram illustrating a state of partial series coupling in the power supply apparatus illustrated in FIG. 1.

FIG. 8 is a simplified diagram illustrating the state of the partial series coupling.

FIG. 9 is a diagram illustrating a state in which a part where a short circuit has occurred is isolated in the power supply apparatus illustrated in FIG. 1.

FIG. 10 is a simplified diagram illustrating the state in which the part where the short circuit has occurred is isolated.

FIG. 11 is a diagram illustrating an example of changes over time in respective voltages of secondary batteries and in amount of heat generated in a short-circuited secondary battery, when a short circuit has occurred in the power supply apparatus illustrated in FIG. 1.

FIG. 12 is a diagram illustrating an example of the changes over time in the respective voltages of the secondary batteries and in the amount of heat generated in the short-circuited secondary battery, when the short circuit has occurred in the power supply apparatus illustrated in FIG. 1.

FIG. 13 is a simplified diagram illustrating a state in which a short circuit has occurred in a power supply apparatus according to a comparative example.

FIG. 14 is a diagram illustrating an example of changes over time in respective voltages of secondary batteries and in amount of heat generated in a short-circuited secondary battery, when a short circuit has occurred in the power supply apparatus illustrated in FIG. 13.

FIG. 15 is a diagram illustrating an example of the changes over time in the respective voltages of the secondary batteries and in the amount of heat generated in the short-circuited secondary battery, when the short circuit has occurred in the power supply apparatus illustrated in FIG. 13.

### DETAILED DESCRIPTION

The present technology will be described below in further detail including with reference to the drawings according to an embodiment.

First, a description is given of a secondary battery to be used in a power supply apparatus according to an embodiment of the present technology.

The secondary battery to be used in the present technology may include, for example, a secondary battery of more than about several hundred milliampere-hours, which involves a risk of actual smoke generation and actual ignition upon occurrence of an internal short circuit. Examples of the secondary battery of more than about several hundred milliampere-hours include a battery of a laminated type or a cylindrical type. The secondary battery to be used in the present technology is not particularly limited in charge and discharge principle. For example, the secondary battery to be used in the present technology is configured to obtain a battery capacity using insertion and extraction of an electrode reactant. The secondary battery to be used in the present technology includes, for example, a positive electrode, a negative electrode, and an electrolyte. In the secondary battery to be used in the present technology, for example, to prevent precipitation of the electrode reactant on a surface of the negative electrode during charging, a charge capacity of the negative electrode is greater than a discharge capacity of the positive electrode. In this case, an electrochemical capacity per unit area of the negative electrode is set to be, for example, greater than an electrochemical capacity per unit area of the positive electrode.

The electrode reactant is not particularly limited in kind, and specific examples thereof include a light metal such as an alkali metal or an alkaline earth metal. Examples of the alkali metal include lithium, sodium, and potassium. Examples of the alkaline earth metal include beryllium, magnesium, and calcium. A secondary battery that obtains a battery capacity using insertion and extraction of lithium is what is called a lithium-ion secondary battery. In the lithium-ion secondary battery, lithium is inserted and extracted in an ionic state.

Next, an issue of the secondary battery to be used in the present technology will be described.

In the secondary battery to be used in the present technology, for example, when a short circuit between the positive electrode and the negative electrode (hereinafter, referred to as an “internal short circuit”) is caused by a foreign object (e.g., a nail or a metal piece) penetrating the secondary battery from an outside, Joule heat is generated around a short-circuited part. Depending on a generation state of the Joule heat, thermal runaway can occur in the secondary battery. Such an internal short circuit in the secondary battery due to a foreign object can occur, for example, upon a crash accident of a mobile body in a case of the secondary battery mounted on the mobile body, or when the foreign object falls on the secondary battery due to a disaster such as an earthquake. An internal short circuit can also be caused by a dendrite.

When local heat generation occurs due to an internal short circuit, there is a very short time until the temperature of a material included in the secondary battery exceeds, for example, a thermal decomposition temperature or an ignition temperature of the material. The most effective way to help to prevent ignition that is to start within a very short time is to suppress the Joule heat generated at a part where the internal short circuit has occurred. A way to achieve such suppression of the Joule heat is to subject the secondary battery in which the internal short circuit has occurred to emergency discharge immediately after detection of the internal short circuit, and to suppress a current flowing into the secondary battery in which the internal short circuit has occurred.

As existing techniques of reducing a risk of ignition caused by an internal short circuit, for example, two or more secondary batteries are disposed in parallel, and a secondary battery in which an internal short circuit has occurred is subjected to emergency discharge by means of a maximum power point tracking (MPPT) circuit to be maximized in output power. For example, a secondary battery in which an internal short circuit has occurred is subjected to emergency discharge by being coupled in series to another secondary battery in which no internal short circuit has occurred, by means of a closed circuit.

However, the method described in the Background section makes it difficult to reduce the size of the MPPT circuit, and increases cost. The method further described in the Background section interrupts power supply to electronic equipment upon the emergency discharge, and is therefore unsuitable for an application in which loss of power is unacceptable even for an instant. To address this, the inventor of the present application proposes below a power supply apparatus that does not interrupt power supply upon emergency discharge and is easily reducible in size.

Next, a configuration of a power supply apparatus 100 according to an embodiment of the present technology will be described.

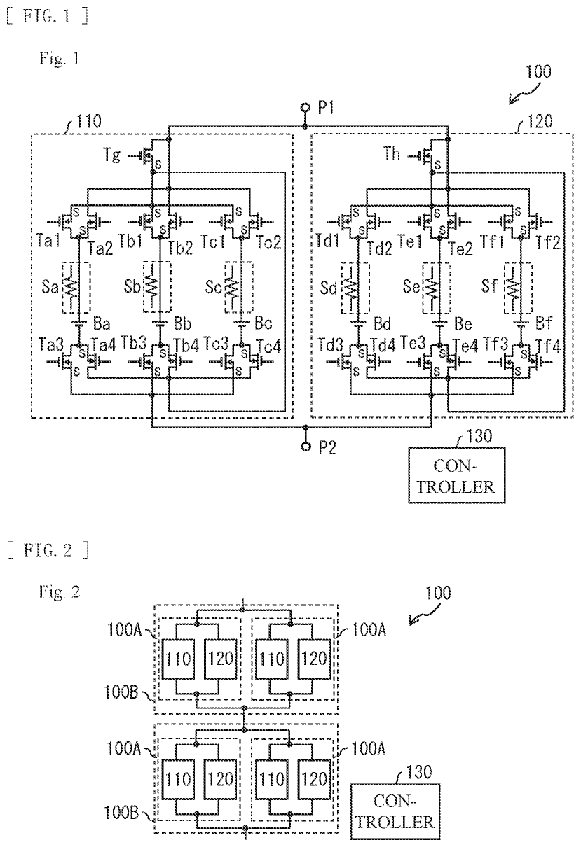

FIG. 1 illustrates an example of a circuit configuration of the power supply apparatus 100 according to an embodiment. As illustrated in FIG. 1, the power supply apparatus 100 includes, for example, two secondary battery units 110 and 120 coupled in parallel to each other. When the two secondary battery units 110 and 120 coupled in parallel to each other are regarded as a secondary battery module 100A, the power supply apparatus 100 may include, for example, two secondary battery modules 100A coupled in parallel to each other, as illustrated in FIG. 2. When the two secondary battery modules 100A coupled in parallel to each other are regarded as a secondary battery module 100B, the power supply apparatus 100 may include, for example, two secondary battery modules 100B coupled in series to each other, as illustrated in FIG. 2.

In the power supply apparatus 100, the number of the secondary battery units coupled in parallel to each other is not limited to two, and may be three or more. In the power supply apparatus 100, the number of the secondary battery modules 100A coupled in parallel to each other is not limited to two, and may be three or more. In the power supply apparatus 100, the number of the secondary battery modules 100B coupled in series to each other is not limited to two either, and may be three or more.

As illustrated in FIG. 1, the power supply apparatus 100 further includes, for example, a controller 130 that controls discharging of the two secondary battery units 110 and 120. The controller 130 includes, for example, a central processing unit (CPU) that executes a predetermined calculation process, a read-only memory (ROM) in which a predetermined control program is stored, and a random-access memory (RAM) in which data is to be temporarily stored. The controller 130 controls the discharging of the two secondary battery units 110 and 120, for example, by executing the control program stored in the ROM.

The secondary battery unit 110 includes, for example, three secondary batteries Ba, Bb, and Bc and three sensors Sa, Sb, and Sc. The sensor Sa is coupled in series to the secondary battery Ba, or is installed in the vicinity of a wiring line coupled to a positive electrode or a negative electrode of the secondary battery Ba. The sensor Sb is coupled in series to the secondary battery Bb, or is installed in the vicinity of a wiring line coupled to a positive electrode or a negative electrode of the secondary battery Bb. The sensor Sc is coupled in series to the secondary battery Bc, or is installed in the vicinity of a wiring line coupled to a positive electrode or a negative electrode of the secondary battery Bc.

The secondary battery unit 110 further includes, for example, four field-effect transistors (FETs) Ta1, Ta2, Ta3, and Ta4 each coupled in series to the secondary battery Ba. The secondary battery unit 110 further includes, for example, four field-effect transistors (FETs) Tb1, Tb2, Tb3, and Tb4 each coupled in series to the secondary battery Bb. The secondary battery unit 110 further includes, for example, four field-effect transistors (FETs) Tc1, Tc2, Tc3, and Tc4 each coupled in series to the secondary battery Bc. Note that in the secondary battery unit 110, the number of secondary batteries is not limited to three, and may be two, or may be four or more.

The field-effect transistors Ta1 and Ta2 are provided on a positive electrode side of the secondary battery Ba. The field-effect transistors Ta3 and Ta4 are provided on a negative electrode side of the secondary battery Ba. A drain of the field-effect transistor Ta1 and a source of the field-effect transistor Ta2 are coupled to each other. A coupling point of the drain of the field-effect transistor Ta1 and the source of the field-effect transistor Ta2 is coupled to the positive electrode of the secondary battery Ba directly or via the sensor Sa. A drain of the field-effect transistor Ta3 and a source of the field-effect transistor Ta4 are coupled to each other. A coupling point of the drain of the field-effect transistor Ta3 and the source of the field-effect transistor Ta4 is coupled to the negative electrode of the secondary battery Ba directly or via the sensor Sa.

The field-effect transistors Tb1 and Tb2 are provided on a positive electrode side of the secondary battery Bb. The field-effect transistors Tb3 and Tb4 are provided on a negative electrode side of the secondary battery Bb. A drain of the field-effect transistor Tb1 and a source of the field-effect transistor Tb2 are coupled to each other. A coupling point of the drain of the field-effect transistor Tb1 and the source of the field-effect transistor Tb2 is coupled to the positive electrode of the secondary battery Bb directly or via the sensor Sb. A drain of the field-effect transistor Tb3 and a source of the field-effect transistor Tb4 are coupled to each other. A coupling point of the drain of the field-effect transistor Tb3 and the source of the field-effect transistor Tb4 is coupled to the negative electrode of the secondary battery Bb directly or via the sensor Sb.

The field-effect transistors Tc1 and Tc2 are provided on a positive electrode side of the secondary battery Bc. The field-effect transistors Tc3 and Tc4 are provided on a negative electrode side of the secondary battery Bc. A drain of the field-effect transistor Tc1 and a source of the field-effect transistor Tc2 are coupled to each other. A coupling point of the drain of the field-effect transistor Tc1 and the source of the field-effect transistor Tc2 is coupled to the positive electrode of the secondary battery Bc directly or via the sensor Sc. A drain of the field-effect transistor Tc3 and a source of the field-effect transistor Tc4 are coupled to each other. A coupling point of the drain of the field-effect transistor Tc3 and the source of the field-effect transistor Tc4 is coupled to the negative electrode of the secondary battery Bc directly or via the sensor Sc.

The secondary battery unit 110 further includes, for example, one field-effect transistor Tg. A source of the field-effect transistor Tg is coupled to respective sources of the field-effect transistors Ta1, Tb1, and Tc1 and to respective drains of the field-effect transistors Ta4, Tb4, and Tc4. A drain of the field-effect transistor Tg is coupled to respective drains of the field-effect transistors Ta2, Tb2, and Tc2 and to a positive electrode terminal P1 of the power supply apparatus 100. The respective sources of the field-effect transistors Ta2, Tb2, and Tc2 are coupled to a negative electrode terminal P2 of the power supply apparatus 100.

The secondary battery unit 120 includes, for example, three secondary batteries Bd, Be, and Bf and three sensors Sd, Se, and Sf. The sensor Sd is coupled in series to the secondary battery Bd, or is installed in the vicinity of a wiring line coupled to a positive electrode or a negative electrode of the secondary battery Bd. The sensor Se is coupled in series to the secondary battery Be, or is installed in the vicinity of a wiring line coupled to a positive electrode or a negative electrode of the secondary battery Be. The sensor Sf is coupled in series to the secondary battery Bf, or is installed in the vicinity of a wiring line coupled to a positive electrode or a negative electrode of the secondary battery Bf.

The secondary battery unit 120 further includes, for example, four field-effect transistors (FETs) Td1, Td2, Td3, and Td4 each coupled in series to the secondary battery Bd. The secondary battery unit 120 further includes, for example, four field-effect transistors (FETs) Te1, Te2, Te3, and Te4 each coupled in series to the secondary battery Be. The secondary battery unit 120 further includes, for example, four field-effect transistors (FETs) Tf1, Tf2, Tf3, and Tf4 each coupled in series to the secondary battery Bf. Note that in the secondary battery unit 120, the number of secondary batteries is not limited to three, and may be two, or may be four or more.

The field-effect transistors Td1 and Td2 are provided on a positive electrode side of the secondary battery Bd. The field-effect transistors Td3 and Td4 are provided on a negative electrode side of the secondary battery Bd. A drain of the field-effect transistor Td1 and a source of the field-effect transistor Td2 are coupled to each other. A coupling point of the drain of the field-effect transistor Td1 and the source of the field-effect transistor Td2 is coupled to the positive electrode of the secondary battery Bd directly or via the sensor Sd. A drain of the field-effect transistor Td3 and a source of the field-effect transistor Td4 are coupled to each other. A coupling point of the drain of the field-effect transistor Td3 and the source of the field-effect transistor Td4 is coupled to the negative electrode of the secondary battery Bd directly or via the sensor Sd.

The field-effect transistors Te1 and Te2 are provided on a positive electrode side of the secondary battery Be. The field-effect transistors Te3 and Te4 are provided on a negative electrode side of the secondary battery Be. A drain of the field-effect transistor Te1 and a source of the field-effect transistor Te2 are coupled to each other. A coupling point of the drain of the field-effect transistor Te1 and the source of the field-effect transistor Te2 is coupled to the positive electrode of the secondary battery Be directly or via the sensor Se. A drain of the field-effect transistor Te3 and a source of the field-effect transistor Te4 are coupled to each other. A coupling point of the drain of the field-effect transistor Te3 and the source of the field-effect transistor Te4 is coupled to the negative electrode of the secondary battery Be directly or via the sensor Se.

The field-effect transistors Tf1 and Tf2 are provided on a positive electrode side of the secondary battery Bf. The field-effect transistors Tf3 and Tf4 are provided on a negative electrode side of the secondary battery Bf. A drain of the field-effect transistor Tf1 and a source of the field-effect transistor Tf2 are coupled to each other. A coupling point of the drain of the field-effect transistor Tf1 and the source of the field-effect transistor Tf2 is coupled to the positive electrode of the secondary battery Bf directly or via the sensor Sf. A drain of the field-effect transistor Tf3 and a source of the field-effect transistor Tf4 are coupled to each other. A coupling point of the drain of the field-effect transistor Tf3 and the source of the field-effect transistor Tf4 is coupled to the negative electrode of the secondary battery Bf directly or via the sensor Sf.

The secondary battery unit 120 further includes, for example, one field-effect transistor Th. A source of the field-effect transistor Th is coupled to respective sources of the field-effect transistors Td1, Te1, and Tf1 and to respective drains of the field-effect transistors Td4, Te4, and Tf4. A drain of the field-effect transistor Th is coupled to respective drains of the field-effect transistors Td2, Te2, and Tf2 and to the positive electrode terminal P1 of the power supply apparatus 100. The respective sources of the field-effect transistors Td2, Te2, and Tf2 are coupled to the negative electrode terminal P2 of the power supply apparatus 100.

The sensor Sa is a sensor that detects a physical quantity serving as a clue for detecting an internal short circuit in the secondary battery Ba, and supplies a signal indicating the physical quantity to the controller 130. The sensor Sa is, for example, an ammeter that detects a current flowing through a shunt resistor coupled in series to the secondary battery Ba. The sensor Sa may be configured to detect, for example, a physical quantity having a predetermined correlation with the current flowing through the shunt resistor described above. The sensor Sa may be, for example, a voltmeter that detects a voltage of the shunt resistor described above, or a magnetometer that detects a magnetic field generated by the wiring line coupled to the positive electrode or the negative electrode of the secondary battery Ba.

The sensor Sb is a sensor that detects a physical quantity serving as a clue for detecting an internal short circuit in the secondary battery Bb, and supplies a signal indicating the physical quantity to the controller 130. The sensor Sb is, for example, an ammeter that detects a current flowing through a shunt resistor coupled in series to the secondary battery Bb. The sensor Sb may be configured to detect, for example, a physical quantity having a predetermined correlation with the current flowing through the shunt resistor described above. The sensor Sb may be, for example, a voltmeter that detects a voltage of the shunt resistor described above, or a magnetometer that detects a magnetic field generated by the wiring line coupled to the positive electrode or the negative electrode of the secondary battery Bb.

The sensor Sc is a sensor that detects a physical quantity serving as a clue for detecting an internal short circuit in the secondary battery Bc, and supplies a signal indicating the physical quantity to the controller 130. The sensor Sc is, for example, an ammeter that detects a current flowing through a shunt resistor coupled in series to the secondary battery Bc. The sensor Sc may be configured to detect, for example, a physical quantity having a predetermined correlation with the current flowing through the shunt resistor described above. The sensor Sc may be, for example, a voltmeter that detects a voltage of the shunt resistor described above, or a magnetometer that detects a magnetic field generated by the wiring line coupled to the positive electrode or the negative electrode of the secondary battery Bc.

The sensor Sd is a sensor that detects a physical quantity serving as a clue for detecting an internal short circuit in the secondary battery Bd, and supplies a signal indicating the physical quantity to the controller 130. The sensor Sd is, for example, an ammeter that detects a current flowing through a shunt resistor coupled in series to the secondary battery Bd. The sensor Sd may be configured to detect, for example, a physical quantity having a predetermined correlation with the current flowing through the shunt resistor described above. The sensor Sd may be, for example, a voltmeter that detects a voltage of the shunt resistor described above, or a magnetometer that detects a magnetic field generated by the wiring line coupled to the positive electrode or the negative electrode of the secondary battery Bd.

The sensor Se is a sensor that detects a physical quantity serving as a clue for detecting an internal short circuit in the secondary battery Be, and supplies a signal indicating the physical quantity to the controller 130. The sensor Se is, for example, an ammeter that detects a current flowing through a shunt resistor coupled in series to the secondary battery Be. The sensor Se may be configured to detect, for example, a physical quantity having a predetermined correlation with the current flowing through the shunt resistor described above. The sensor Se may be, for example, a voltmeter that detects a voltage of the shunt resistor described above, or a magnetometer that detects a magnetic field generated by the wiring line coupled to the positive electrode or the negative electrode of the secondary battery Be.

The sensor Sf is a sensor that detects a physical quantity serving as a clue for detecting an internal short circuit in the secondary battery Bf, and supplies a signal indicating the physical quantity to the controller 130. The sensor Sf is, for example, an ammeter that detects a current flowing through a shunt resistor coupled in series to the secondary battery Bf. The sensor Sf may be configured to detect, for example, a physical quantity having a predetermined correlation with the current flowing through the shunt resistor described above. The sensor Sf may be, for example, a voltmeter that detects a voltage of the shunt resistor described above, or a magnetometer that detects a magnetic field generated by the wiring line coupled to the positive electrode or the negative electrode of the secondary battery Bf.

Next, an operation of the power supply apparatus 100 according to an embodiment will be described.

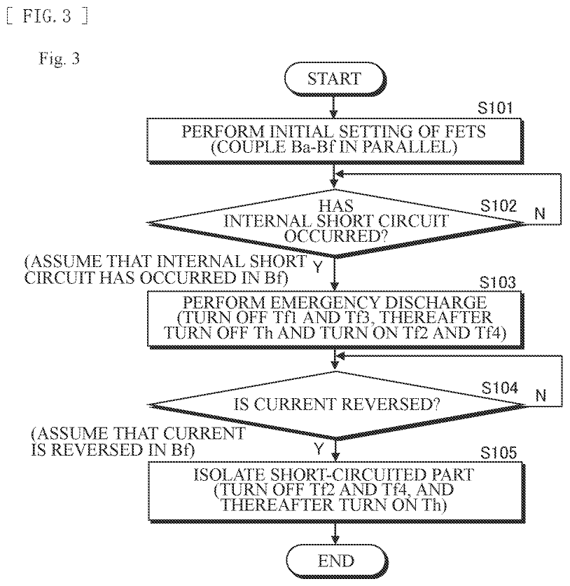

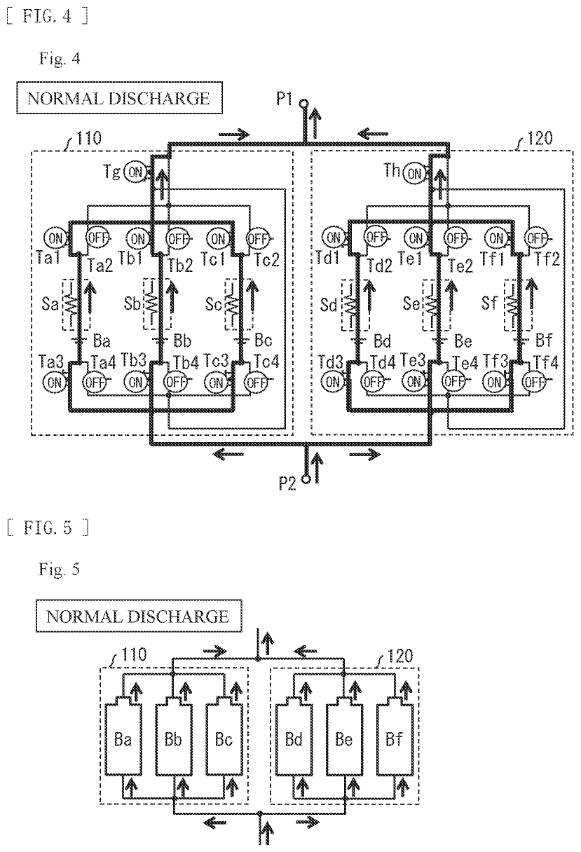

FIG. 3 illustrates an example of an emergency discharge procedure for the power supply apparatus 100. First, the controller 130 performs initial setting of each of the field-effect transistors (Ta1 to Th) (step S101). For example, as illustrated in FIGS. 4 and 5, the controller 130 so performs the initial setting of each of the field-effect transistors (Ta1 to Th) that the secondary batteries Ba to Bf are coupled in parallel to each other. The controller 130 turns on, for example, the field-effect transistors Ta1, Ta3, Tb1, Tb3, Tc1, Tc3, Td1, Td3, Te1, Te3, Tf1, Tf3, Tg, and Th. In addition, the controller 130 turns off, for example, the field-effect transistors Ta2, Ta4, Tb2, Tb4, Tc2, Tc4, Td2, Td4, Te2, Te4, Tf2, and Tf4.

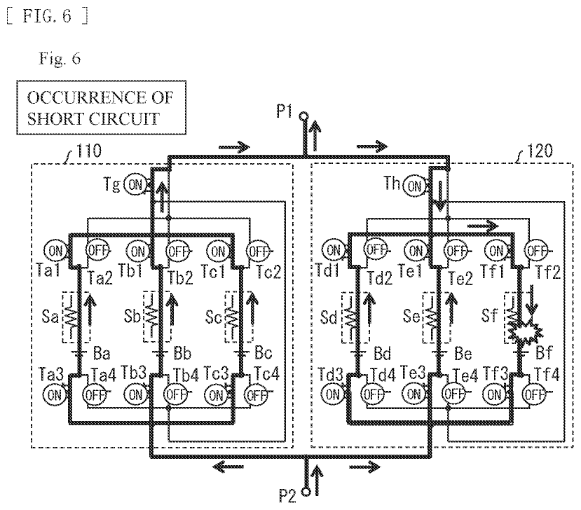

After the above-described initial setting is completed, the controller 130 detects whether an internal short circuit has occurred in any of the secondary batteries Ba to Bf, using respective detection results obtained from the sensors Sa to Sf (step S102). For example, assume that a short circuit has occurred in the secondary battery Bf, as illustrated in FIG. 6, when the sensors Sa to Sf are current sensors. In this case, for example, a current outputted from each of the secondary batteries Ba to Be in which no short circuit has occurred flows into the secondary battery Bf in which the short circuit has occurred, as illustrated in FIG. 6. In this case, the sensor Sf detects the current flowing into the secondary battery Bf, and supplies the detection result to the controller 130.

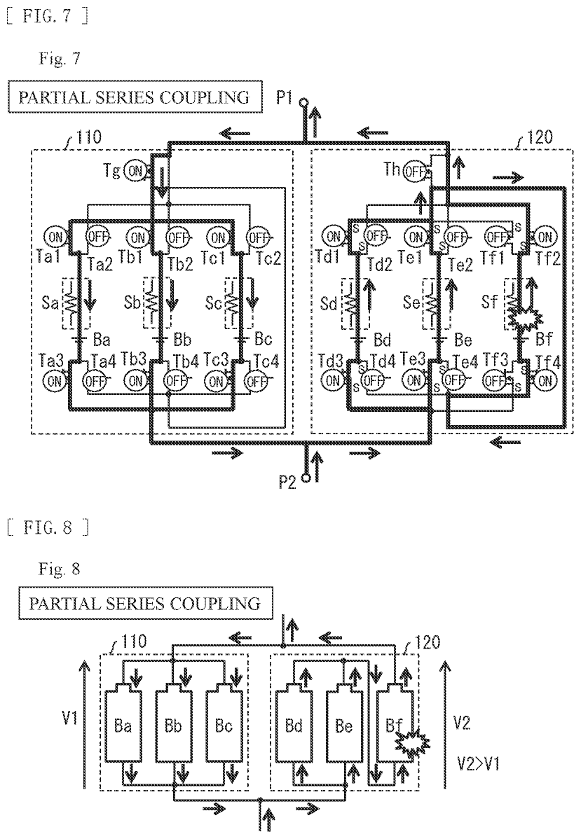

The controller 130 determines that a short circuit has occurred in the secondary battery Bf based on the detection result supplied from the sensor Sf (step S102; Y), and performs the emergency discharge (step S103). Upon the emergency discharge, the controller 130 switches coupling between the secondary battery Bf in which the short circuit has occurred and each of the secondary batteries Bd and Be in which no short circuit has occurred, from parallel coupling to series coupling, by controlling the field-effect transistors Ta1 to Th. For example, the controller 130 turns off the field-effect transistors Tf1 and Tf3, and thereafter turns off the field-effect transistor Th and turns on the field-effect transistors Tf2 and Tf4. As a result, for example, as illustrated in FIGS. 7 and 8, the secondary battery Bf in which the short circuit has occurred is coupled in series to each of the secondary batteries Bd and Be in which no short circuit has occurred, and the positive electrode of the secondary battery Bf is coupled to the positive electrode terminal P1 of the power supply apparatus 100.

In this case, when the secondary battery Bf is coupled in series to each of the secondary batteries Bd and Be, a voltage V2 of the secondary battery unit 120 as a whole is higher than a voltage V1 of the secondary battery unit 110 as a whole by an amount corresponding to a voltage of the secondary battery Bf. Accordingly, a current starts flowing from the secondary battery unit 120 into the secondary battery unit 110. That is, discharging of the secondary battery unit 120 is started, and charging of the secondary battery unit 110 is started. The discharging of the secondary battery unit 120 and the charging of the secondary battery unit 110 are continued until V2 becomes equal to V1. Thereafter, when V2 becomes lower than V1, a current starts flowing from the secondary battery unit 110 into the secondary battery unit 120. That is, a current flowing direction in the secondary battery unit 120 is reversed.

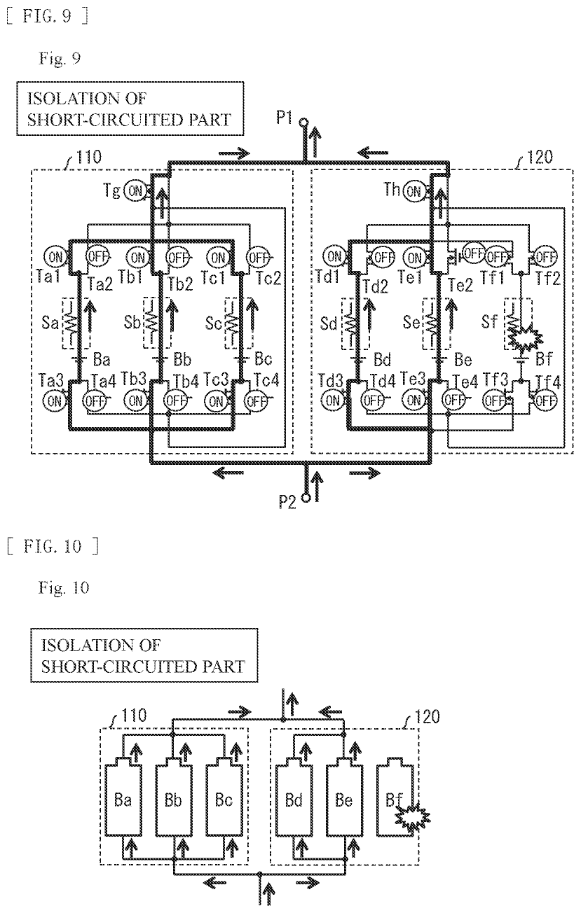

When the controller 130 determines that a direction of a current flowing through the secondary battery Bf in which the short circuit has occurred is reversed, based on the detection result supplied from the sensor Sf (step S104; Y), the controller 130 isolates a part where the short circuit has occurred (step S105). For example, the controller 130 turns off the field-effect transistors Tf2 and Tf4, and thereafter turns on the field-effect transistor Th to, for example, separate the secondary battery Bf in which the short circuit has occurred from a current path of each of the secondary batteries Bd and Be in which no short circuit has occurred, as illustrated in FIGS. 9 and 10.

Note that a timing of isolating the secondary battery Bf in which the short circuit has occurred is not limited to the timing when the direction of the current flowing through the secondary battery Bf in which the short circuit has occurred is reversed. For example, the controller 130 may isolate the part where the short circuit has occurred, when determining that the magnitude of the current flowing through the secondary battery Bf in which the short circuit has occurred is less than or equal to a predetermined threshold, based on the detection result supplied from the sensor Sf. For example, the controller 130 may isolate the part where the short circuit has occurred, when a predetermined time elapses since the partial serialization.

The emergency discharge in the power supply apparatus 100 is performed as described above. The above-described operation of the emergency discharge is performed using the field-effect transistors Ta1 to Th. Therefore, it is unnecessary to use an MPPT circuit, and it is possible to perform the operation of the emergency discharge with a small device. In addition, it is possible to perform the emergency discharge without interrupting current supply from the power supply apparatus 100 to an external load. Therefore, there is no risk of losing the function of the power supply apparatus 100 even during the emergency discharge.

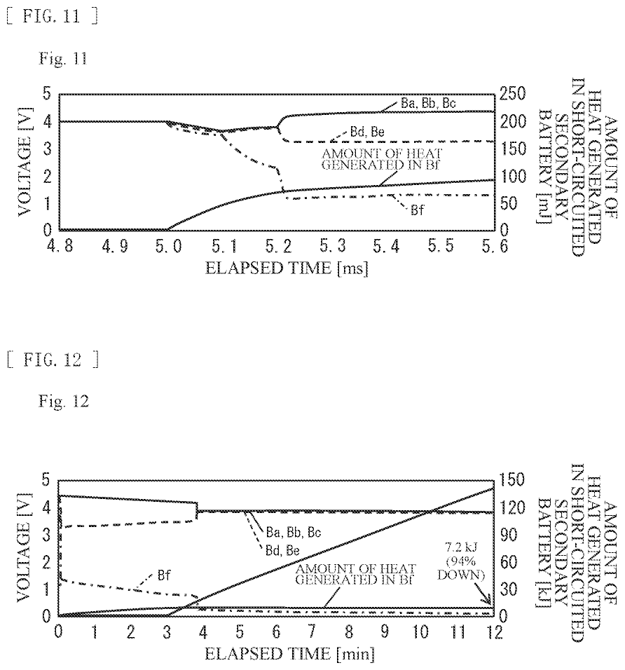

FIGS. 11 and 12 each illustrate an example of changes over time in the respective voltages of the secondary batteries Ba to Bf and in amount of heat generated in the secondary battery Bf in which the short circuit has occurred, when the short circuit has occurred in the power supply apparatus 100. The unit of a horizontal axis in FIG. 11 is milliseconds, and the unit of a horizontal axis in FIG. 12 is minutes. FIGS. 11 and 12 each present a result of examination on an effect of the power supply apparatus 100 performed by means of an electronic circuit simulator.

In the electronic circuit simulator, when describing each of the secondary batteries Ba to Bf, a capacitor (having an initial voltage of 4 V, an internal resistance of 30 mΩ, and a parasitic inductance of 10 nH) that had a capacitance of 4 kF was used instead of a voltage source. A reason for this is that a current is unlimitedly available from the voltage source and there is no concept of capacity in the voltage source. The capacitor having the capacitance of 4 kF was used to reproduce decreasing behavior of the voltage of each of the secondary batteries Ba to Bf caused by discharging. In the electronic circuit simulator, the total energy of the secondary batteries Ba to Bf was set to 32 kJ×6=192 kJ, and a constant power load of 10 W was coupled to each of the secondary batteries Ba to Bf. That is, the load had been constantly suppled with power.

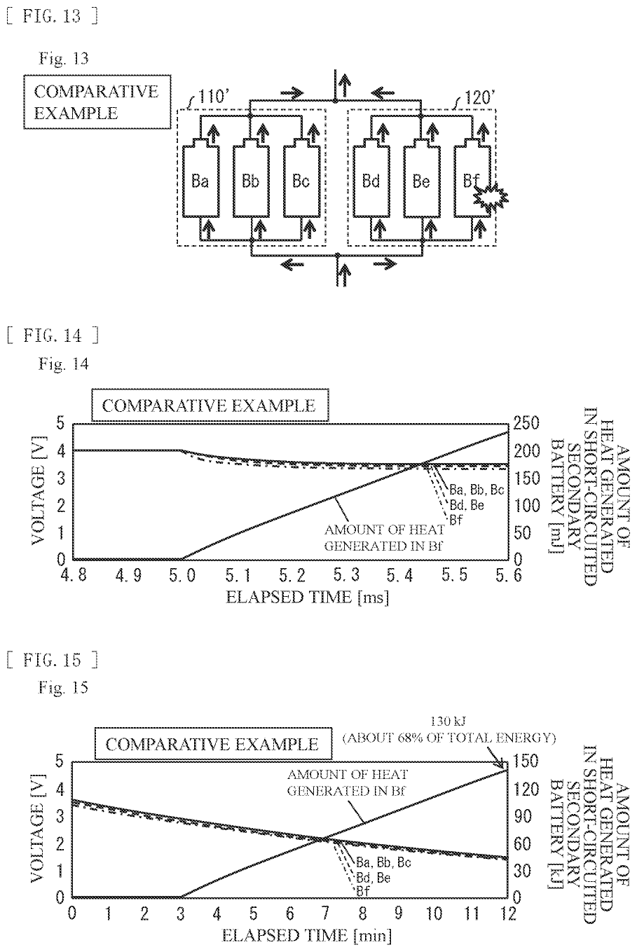

In the electronic circuit simulator, an internal short circuit was caused in the secondary battery Bf at a timing corresponding to an elapsed time of 5 ms. Specifically, an additional resistor was coupled in parallel to the secondary battery Bf, and a resistance value of the additional resistor was decreased from 1 MΩ to 30 mΩ at the timing corresponding to the elapsed time of 5 ms. Simulations were performed of a case where the secondary battery Bf was serialized to the secondary batteries Bd and Be which are connected in parallel (see FIG. 8) and of a case where the secondary battery Bd, Be and Bf were coupled in parallel to each other (see FIG. 13). FIGS. 11 and 12 each present a result of the case where the partial serialization was performed. FIGS. 14 and 15 each present a result of the case where the partial serialization was not performed.

In the case where the partial serialization was not performed, the voltages of all of the secondary batteries Ba to Bf decreased from 5 ms, as illustrated in FIG. 14. A reason for this is that the energy of all of the secondary batteries Ba to Bf flowed into the secondary battery Bf in which the internal short circuit had occurred. As illustrated in FIG. 15, at a timing corresponding to an elapsed time of 12 minutes, energy of 130 kJ corresponding to about 68% of the total energy was converted into heat in the secondary battery Bf in which the internal short circuit had occurred.

In contrast, in the case where the partial serialization was performed, only the secondary battery Bf in which the internal short circuit had occurred was subjected to the emergency discharge, as illustrated in FIG. 11. The secondary battery Bf was sufficiently discharged, and thereafter, was isolated, as illustrated in FIG. 12. As a result of such a control, the amount of heat generated in the secondary battery Bf in which the internal short circuit had occurred became 7.2 kJ at the timing corresponding to the elapsed time of 12 minutes. This indicates that the amount of heat generated in the secondary battery Bf in which the internal short circuit had occurred was reduced by 94%, as compared with the case where the partial serialization was not performed. Note that, as illustrated in FIGS. 11 and 12, there was no interruption in the current flowing through each of the secondary batteries Ba to Be. This indicates that power was constantly supplied to the load.

Next, effects of the power supply apparatus 100 according to an embodiment will be described.

In an embodiment, it is possible to switch the coupling between the secondary battery Bf and each of the secondary batteries Bd and Be from the parallel coupling to the series coupling. Thus, for example, when an internal short circuit occurs in the secondary battery Bf, it is possible to cause a discharge current of the secondary battery unit 120 including the secondary battery Bf in which the internal short circuit has occurred to flow into the other secondary battery unit 110. As a result, it is possible to perform the emergency discharge of the secondary battery Bf in which the internal short circuit has occurred, without interrupting the power supply to the load.

In an embodiment, the sensors Sa to Sf are provided that each detect, for example, the current flowing through corresponding one of the secondary batteries Ba to Bf. It is possible to switch the coupling between the secondary battery Bf and each of the secondary batteries Bd and Be from the parallel coupling to the series coupling based on the detection result obtained from each of the sensors Sa to Sf. This makes it possible to, for example, when an internal short circuit occurs in the secondary battery Bf, cause the discharge current of the secondary battery unit 120 including the secondary battery Bf in which the internal short circuit has occurred to flow into the other secondary battery unit 110. As a result, it is possible to perform the emergency discharge of the secondary battery Bf in which the internal short circuit has occurred, without interrupting the power supply to the load.

In an embodiment, after the emergency discharge is performed, the secondary battery Bf in which the internal short circuit has occurred is separated from the current path of each of the secondary batteries Bd and Be in which no internal short circuit has occurred. This eliminates the risk of charging the secondary battery Bf in which the internal short circuit has occurred, therefore making it possible to prevent occurrence of thermal runaway in the secondary battery Bf.

In an embodiment, the coupling between the secondary battery Bf and each of the secondary batteries Bd and Be is achieved by the field-effect transistors Ta1 to Th. This makes the MPPT circuit unnecessary in performing the emergency discharge. It is therefore possible to reduce the size of the power supply apparatus 100.

The effects described herein are mere examples, and effects of the present technology are therefore not limited thereto those described herein. Accordingly, the present technology may achieve any other suitable effect.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A power supply apparatus comprising:
secondary battery units coupled in parallel to each other; and
a controller that controls discharging of the secondary battery units, wherein
the secondary battery units each include
secondary batteries, and
a switching unit that switches coupling of the secondary batteries, and
the controller switches coupling between a first secondary battery and each of one or more second secondary batteries from parallel coupling to series coupling by controlling the switching unit, the first secondary battery being any one of the secondary batteries, the one or more second secondary batteries being one or more of the secondary batteries other than the first secondary battery.

2. The power supply apparatus according to claim 1, wherein
the secondary battery units each further include sensors that each detect a current flowing through corresponding one of the secondary batteries or a physical quantity having a predetermined correlation with the current, and
the controller switches the coupling between the first secondary battery and each of the one or more second secondary batteries from the parallel coupling to the series coupling by controlling the switching unit based on a detection result obtained from each of the sensors.

3. The power supply apparatus according to claim 2, wherein, when determining that a short circuit has occurred in the first secondary battery based on the detection result obtained from corresponding one of the sensors, the controller switches the coupling between the first secondary battery and each of the one or more second secondary batteries from the parallel coupling to the series coupling by controlling the switching unit.

4. The power supply apparatus according to claim 2, wherein, by controlling the switching unit, the controller switches the coupling between the first secondary battery and each of the one or more second secondary batteries from the parallel coupling to the series coupling, and thereafter separates the first secondary battery from a current path of each of the one or more second secondary batteries.

5. The power supply apparatus according to claim 3, wherein, when determining that a direction of a current flowing through the first secondary battery is reversed, based on the detection result obtained from the corresponding one of the sensors, the controller separates the first secondary battery from a current path of each of the one or more second secondary batteries by controlling the switching unit.

6. The power supply apparatus according to claim 1, wherein the switching unit includes transistors.

7. The power supply apparatus according to claim 1, wherein
the switching unit includes first to fourth transistors for each of the secondary batteries, and further includes a fifth transistor provided in common to the secondary batteries,
a drain of the first transistor and a source of the second transistor are coupled to each other, and a coupling point of the drain of the first transistor and the source of the second transistor is coupled to a positive electrode of corresponding one of the secondary batteries,
a source of the first transistor is coupled to a source of the first transistor provided for another one of the secondary batteries and to a source of the fifth transistor,
a drain of the second transistor is coupled to a drain of the second transistor provided for the other one of the secondary batteries and to a drain of the fifth transistor,
a drain of the third transistor and a source of the fourth transistor are coupled to each other, and a coupling point of the drain of the third transistor and the source of the fourth transistor is coupled to a negative electrode of the corresponding one of the secondary batteries,
a source of the third transistor is coupled to a source of the third transistor provided for the other one of the secondary batteries, and
a drain of the fourth transistor is coupled to a drain of the fourth transistor provided for the other one of the secondary batteries and to the source of the fifth transistor.

8. The power supply apparatus according to claim 7, wherein
a drain of the fifth transistor is coupled to a drain of the fifth transistor provided for another one of the secondary battery units, and
the source of the third transistor is coupled to a source of the third transistor provided for the other one of the secondary battery units.
